(19) United States
(12) Patent Application Publication
(10) Pub. No.: US 2019/0123976 A1
(43) Pub. Date: Apr. 25, 2019

(54) Computer Workflow Management Through User Defined Spaces

(71) Applicant: Alexander Coffin, Madison, WI (US)

(72) Inventor: Alexander Coffin, Madison, WI (US)

(21) Appl. No.: 16/165,706

(22) Filed: Oct. 19, 2018

Related U.S. Application Data
(60) Provisional application No. 62/575,000, filed on Oct. 20, 2017.

(51) Int. Cl. H04L 12/24; H04L 29/08

(52) U.S. Cl. CPC H04L 41/22; H04L 67/10; H04L 67/14

(57) ABSTRACT

A user interface provides multiple virtual desktops each linked to necessary resources which can be preloaded at the time the virtual desktop is given focus. This preloading can obtain necessary resources, open necessary applications and files, and initialize applications to a predefined state.

### CROSS REFERENCE TO RELATED APPLICATION

This application claims the benefit of U.S. Provisional application 62/575,000 filed Oct. 20, 2017 and hereby incorporated by reference

### BACKGROUND OF THE INVENTION

The present invention relates generally computer user interfaces, and more specifically to a user interface for tracking, logging and processing user input for workflow automation.

Software applications and programs are typically accessed in sequential order by a user in order to open required resources to complete a task. These resources have started to stack on top of others in the systems GUI while a user operates on the computing system causing too much time spent context switching. While the user has freedom today to organize these applications in any method they like, there is currently no way for a user to structure their Operating System's home graphical environment in a manner that would allow only the required resources.

In addition, all current virtual desktop environments included in the most popular operating systems today, Window 10 and Apple OSx, are lacking a method for a user to archive the structure of these Sessions with the use of a user input tracking solution to automatically add new resources to the system for future use. This is leading to a user wasting time locating these resources individually and allocating them to the desired location.

The system proposed advantageously structures the operating system's Graphical User Interface and monitors the actions of the user to eliminate the need for most of the user's repetitive manual input.

Furthermore, processing and accumulating repetitive user inputs at the operating system does not exist in today's environment and allows for a great deal of improvement to a user's function and operating efficiency while on the computer.

There are various solutions that offer different functions for a user to structure their operating system's Graphic User Interface by means of the task and each of these carries specific functions that sets them apart in their industry. Some of these functions are also similar in nature and it is with respect to these other vendors that the disclosure made herein is presented.

### SUMMARY OF THE INVENTION

The present invention provides and improved user interface supporting multiple virtual desktops or “Sessions” for user organization. The interface defines techniques for organizing resources to process task items, allowing a user to define the Session and determine what resources are necessary. A user can also determine that an environment can be initiated with a blank state where the system will track user input to determine the relevant resources required for the task. These Sessions are saved to the local memory resource of the computing system for future access to a recurring task. An event tracker that automates resource allocation for task completion.

This user input tracking or event listener records all inputs and intelligently highlights the required file directory for each item regardless of data type. The data is then logged locally on an internal memory source on the computer and remotely on a server for processing.

The user event listener can also allow for remote processing to occur on the server to determine common, recurring actions that take place each time the user accesses a workflow. After processing is done to determine the recurring tasks a script is generated to offer automation of these actions. The remote processing also includes the potential for a user to track the amount of time spent inside of a given session for professional purposes.

Currently, solutions for automating user input processes exist and mostly focus on a user defining the task to automate but no functions exist that allow a user's input to be tracked. The proposed solution would allow a user to focus on the task being accomplished while the system leverages a machine learning algorithm to identify key commonalities of user actions to help expedite workflows.

Where the proposed solution stands out and is unique is the ability to record key user resources and actions necessary for completion behind the scenes. This eliminates user action for each individual step.

The proposed solution also considers the capability of tracking time using specific applications. Solutions exist today that allow for the time spent in individual applications to be monitored but not the environment that has been labeled.

These particular objects and advantages may apply to only some embodiments falling within the claims and thus do not define the scope of the invention.

### BRIEF DESCRIPTION OF THE DRAWINGS

FIG. 1 is a simplified representation of a network structure where a local computing device connects to a cloud network for remote storage and processing;

FIG. 2 is a block diagram providing an example of the hardware structure the defined invention could operate on;

FIG. 3 is a block diagram of a cloud computer platform for the remote storage and processing to take place;

FIG. 4 is a flowchart of a program executed by the computer and diagramed highlighting the steps the event listener takes when in operation;

FIG. 5 is a flowchart of a program used to help generate process automation;

FIG. 6 a screen display showing a sidebar used in the desired environment; and

FIG. 7 a screen display of a Launch screen for user customization.

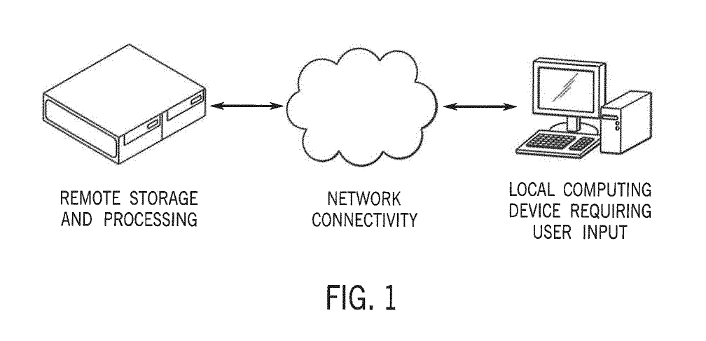

### DETAILED DESCRIPTION OF THE PREFERRED EMBODIMENT

### System Overview

The present invention provides the ability for a user to organize various “workflows” being tasks they perform in their work, on his or her computer using multiple “environments” represented as sequentially displayable “desktops” on a computer monitor screen. A workflow for a lawyer, for example, may be work on a particular client matter or account. The user may associate a different “environment” with each workflow they are performing to aid in organization and efficient use of computer resources such as memory. The environment holds instances of computer software required for the workflow and when the environment has “focus” meaning that it is displayed to the user, all user input and output is channeled to those application instances.

Each workflow can be labeled for the user to quickly recognize which environment has “focus” versus which environment might need to be activated for the next task. An example of a label for an Account Manager would be “Client A” where this references and stores the workflow for that account.

The invention provides a program working in the background to allow environments to be closed and opened or switched among easily and efficiently. When an environment is closed, a state table representing the environment and holding the state of the application programs is saved so that when the environment is opened again the required programs are loaded with their argument files and settings and in some cases showing the last point in a file that a user was working on.

Thus for example, a first workflow, which may be given a user friendly name by the user, may hold a copy of a word processor, a spreadsheet program, and a browser program. Each of these application programs may be associated with startup state for example, the word processor may be associated with a word processing document open to a particular page, line and word, the spreadsheet may be associated with a particular open spreadsheet document highlighting a specific cell or formula last accessed, and the browser may be associated with particular websites displayed in tabs. Identifiers for these programs and their files are saved in the state file so that when the environment is opened (after previously being closed) each of these application programs may be opened with the proper files. In some cases the particular location in the file may also be restored.

When the environment is closed, the state information is preserved until the next time this environment is opened.

When the user moves among environment, in some cases, application programs associated with environment that do not have focus (but have not been closed) are closed to conserve system resources, although this may be optional.

The program implements these features without the need to have access to internal state data of a variety of different possibly proprietary applications used in the environment, by monitoring the user's interaction with the application programs through keystroke and mouse tracking, for example, so that states of the various programs can be reproduced when workspaces are opened, closed, or switched among. Generating this state information requires, in some cases, the use of artificial intelligence such as supervised machine learning, because there may not be a simple one-to-one mapping between state and observed keystrokes. In some applications where the current state information is hidden in the proprietary software, the system traces the user interaction and then identifies the state location of the file desired to be saved into the workflow. A key application where this currently occurs is in Adobe PDF Viewer where, when opening a file from inside of the application it is not possible to leverage the user interaction to grab the location.

The program provides the ability to track the amount of time a user is active in each environment by the user selecting a “time tracking” method inside of the environment's settings page. This environment settings page includes the current files and applications, the name of the structured workflow, the ability for a user to determine whether they would like to add the environment to their favorites list, and the ability to track the amount of time spent on that workflow by day or week. The programs time tracking solution is able to be pulled in daily, weekly, or monthly increments to highlight the amount of time spent in a specific workflow. An example use case of this feature is a consultant who currently charges for the time spent working on a desired project. By automatically tracking the amount of time spent in each environment the consultant no longer needs to be distracted by manually turning on and off the clock in current applications.

The program implements this time tracking capabilities by monitoring what “focused” environment the user is currently active and maintaining a data table with the date, start and stop time for each “session” that the user is active in the workflow. When a user ceases activity in the focused environment the new start and stop time are added to the table under the given date and then aggregated to show the total time spent during the calendar day, week and month.

The time tracking report provided by the program also has the functionality to accumulate the time spent through all defined, or labeled, workflows and show a percentage scale for time spent in each environment for the calendar day, week or month. For example, this could be useful for managers who are looking to see how much time their employees spend on a set of defined accounts to readjust their market strategy.

The program allows for each environments state to be saved to a remote storage solution outside of the operating hardware. This provides the capability to have the environment to be accessed from a different system with similar hardware attributes, for a user to share a specific workflow with another user, and for an environment to be recovered in the event that the original hardware becomes corrupt.

If a user determines an environment is to be used for local and “remote” or on another machine, the program will compare storage locations of each file to ensure that the system has global access. In the event that a user assigns an environment to be accessed from a remote setting or user to user sharing event and the file is stored only on the local hardware then the user will receive a notification that they will need to fix this error. An example is a college student working on a research paper with a team. If the student decides to save a word processing document on their local storage drive and not on a “cloud storage solution”, like google drive or Microsoft OneDrive, then the user will be notified that they will not be able to access the specific files outside of the original hardware.

While the program tracks user input it is logged to a local database recording the resources accessed and the specific actions taken to progress the desired workflow. Once a user decides to move from one focus environment to the next the local database is recorded to a remote storage solution and categorized under the environment name with the date produced. Once the data is uploaded to a remote storage solution, like Amazon Web Services, the data is processed with a machine learning algorithm where the system compares all interactions from the first logged environment to the most recent and looks for sets of common action that occur during the workflow.

In the event that the remote system recognizes a defined number of common, recurring actions the system then processes an automated script that will allow the user to automate the recurring actions. Once the user logs into their machine and the user accesses the desired environment they are presented with the option to automate the specific functions, and the scripts are downloaded to the local machine.

An example of the automated script is a sales representative who on a weekly basis needs to pull down sales reports to update a forecast. If on every Friday he goes to the same resources and pulls the same reports the remote processing will notice this habit and develop an automation script to allow this process to be done without the user's involvement giving the user the flexibility to focus on other key items while the system is working.

The program offers functionality to manage a task list for each specific workflow or environment. The task list sources include the ability to leverage API's from popular third-party applications, like Asana, Outlook and Trello which are common applications in 2017. The task list integration provides an intelligent way for the user to itemize which tasks respond to the list of environments and will only show the respective tasks when in that environment. Tasks that are pulled into the list are simple mirror images of the lists stored by outlook or other applications and through Application Programming Interfaces the program mimics a command the user might input back to the original source (Ex. Clicking “complete” on a task in the sidebar will set the status of the action in Outlook to complete).

The invention provides a task management system that intelligently builds environments based on the users aggregated task list from the users defined sources. The system gradually builds intelligence by monitoring the users recurring use of the task management solution that leverages local and 3rd party solutions that integrate into the program. The program starts with learning the user's habits by tracking common “items” of terms and phrases used for each environment and correlates to common applications or files leveraged in the defined environment. Once the system tracks a certain amount of common used items per task the system starts to automatically offer the ability for the user to create an environment based on the task. This is presented by offering a “Session” call to action box to the right of the task in the side-bar where a user can select it to create a new environment that is automatically generated by the program with the common programs used.

As an example, an engineer working on a specific project might leverage outlook to list out their tasks which could be: “Review team software edits from the previous day, answer any questions remaining from the previous edit, and commence edit for next revision.” Once the user has categorized the tasks under the project and has told the program that this category reflects directly on the selected environment, the user will see the list on the sidebar. This list will be shown itemized with the capability of setting the task status to done.

Each workflow, or defined environment, is capable of being password protected, or “locked” by the user to protect or limit access to the structure saved in that session. A user might have two different use cases for this capability: the first being the ability to restrict access to unauthorized users to view the full structure of the state. The second example could be used in education or home environments where a parent might want to limit the tools a student can access while focusing on their homework.

In the presently preferred embodiment the invention offers a novel approach to user workflow management through the ability to track, process and automate user inputs while identifying necessary files and other software solutions necessary for completion of the task.

The invention would operate in an environment where the user controls the specific virtual desktop or graphical user environment where tasks are being completed. These defined environments by the user can be labeled for the desired purpose of the environment and controlled through a sidebar or main launch screen. In the Main Launch Screen a user is also able to modify the settings

When the user enters into the selected environment or desktop the system will automatically begin to track the user's input by reading the task manager records and recording specific open and closed file types. Example file types are: .txt, .word, .xcl, web browser urls, etc.

These tracked and recorded user actions allow the user to save the file state in that specific desktop environment and allow the user to save, close and return to that specific state when needed.

Tracked actions are logged to a cloud storage medium where machine learning processes the user input to track common sequences. After a specific set of matches are recorded the user is presented with the ability to automate the functionality in the specified workflow.

The typical user process would consist of:
1) User opens software to choose desired environment to work on task.
2) If no environment exists the user structures the environment by selecting the necessary resources for task completion and names desired space. The user may give this new environment a convenient name and that name will appear in a taskbar that is used allow the user to switch easily between environments.
3) User has the option to select whether a time tracking will take place for each environment. If the user selects time tracking, an internal clock will start tracking the time during which the particular environment has focus. When the user closes that environment or switches to a different environment, that clock will close holding its time until the next time the associated environment is opened. In the latter case, a new clock associated with the newly opened environment may start keeping track of time. In this way the user can reconstruct how much time they put on to different workflows even though they may switch between environment many times during the day
4) Environment is built in a new desktop or graphical space and the event listener process starts. The user is presented initially with a blank screen which may be populated with applications that will be used in that environment
5) Event listener records user input via monitoring user clicks and file access. By tracking keyboard and mouse usage, a current state of the environment may be maintained for the purpose of reconstructing that environment between environment switches or when the environment is closed and opened again
6) Event listen records until user clicks to save or close active environment.
7) If save or close are activated then the user is shown the resources in the current environment and determines what files are relevant. Those files are maintained in the state record so that they can be opened when the environment is reactivated
8) While this occurs the user's activity is logged to a cloud storage solution for processing recurring activities between user logs. Cloud storage is optional, the same data can be stored locally, but this storage allows the system to work in a more portable manner between different computer systems (by simply accessing the stored states that are contained in the cloud) and also permits a business model that rents rather than sells the software.
9) User recurring activity is determined and a script is generated to automate these tasks. An example of this is an account manager who runs a weekly report to determine sales metrics and whether they are on track to hit their numbers. The system has noticed that each Friday the user goes to their company's internal website and pulls down the same set of data to be analyzed. When the script is written the user will be given a prompt to run the automated script where the hardware will execute opening the companies internal resource, selecting the data sets to be downloaded and then executing the download. The automation eliminates the manual task of pulling the reports and the user can now spend that time on more productive items while the action is executed.

### DETAILED DESCRIPTION

Computing environments currently allow for a wide variety of user modification to uniquely complete a task. While this is advantageous to the user it also poses an issue with efficiency and time required to complete a given task. The system proposed is built with the purpose of tracking user input to automate tasks and focus the user on the tasks required.

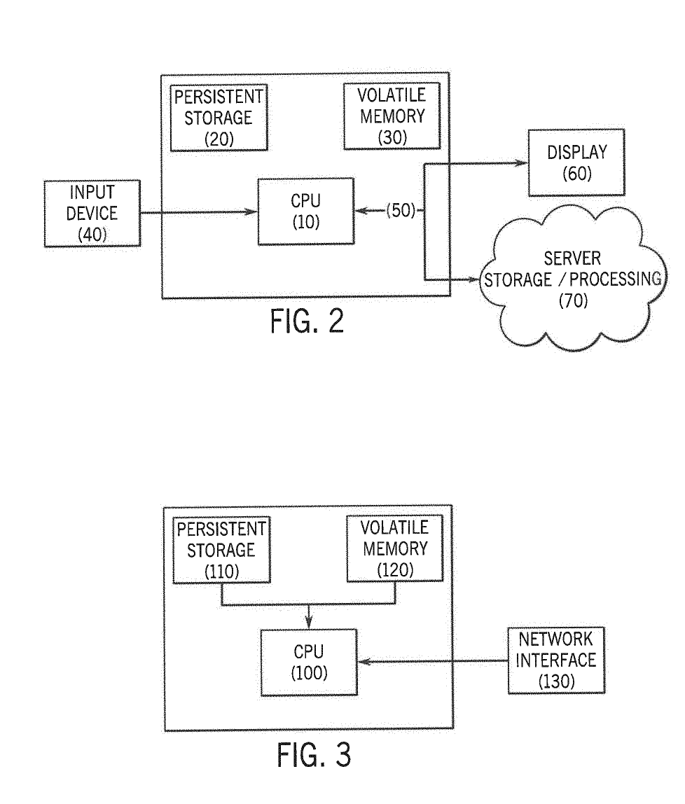

In the presently preferred embodiment the invention offers a novel approach to user workflow management through the ability to track, process and automate user inputs while identifying necessary files and other software solutions necessary for completion of the task. The proposed invention operates on a hardware platform (FIG. 2) that includes a CPU (10), persistent storage (20), volatile storage (30), input device (40), output device (50), graphical user interface (60) and a network interface (70) to be connected, sometimes intermittently to a cloud storage processing solution. A specific example of a suitable hardware platform is a Microsoft Surface running Windows 10 or Apple MacBook Pro, but it is to be understood that the teachings herein can be modified for other presently known or future hardware platforms.

The cloud solution (FIG. 3) would consist of a CPU (100), persistent storage (110), volatile storage (120) and network interface (130). A specific example of a suitable hardware platform is a Dell EMC 14G PowerEdge Server, but it is to be understood that the teachings herein can be modified for other presently known or future hardware platforms.

Solving a user's efficiency & reducing the time it takes to manually complete a task requires the ability to provide a more structured environment to the user. This environment will be structured with only the required resources necessary for the task. The proposed invention allows for the system to monitor the user input and track new or removed resources for the task and automatically adjust the environment as required.

The described environment gives the user the ability to track the amount of time they spend in each given environment and/or the amount of time spent leveraging different resources inside of a labeled environment. This kind of capability would allow a professional who charges by an allotted amount of time to easily account for the amount of time spent on a specific task.

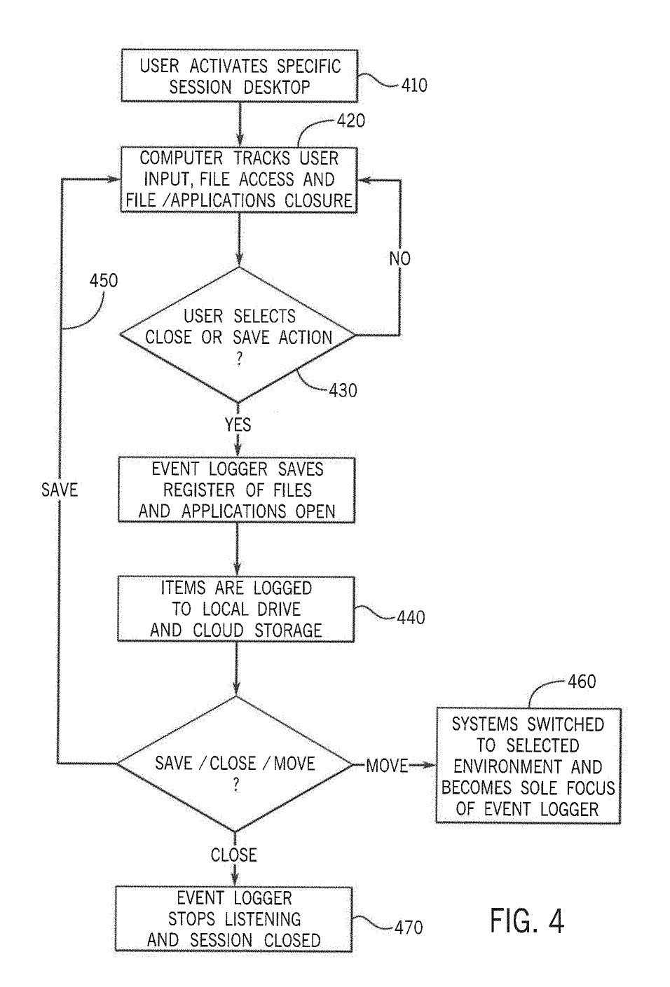

The system process contains the following flow: (FIG. 4) User selects the desired environment structured by the user and launches the applications and files necessary for the task (410). If the user has previously set up this environment, these tasks are automatic and not performed by the user. If the user has not defined the desired environment they are required to select the necessary resources, meaning programs that will run in the particular environment. Once the environment is launched the event listener (420) begins to function in the background listening to the system activity for which files and applications are accessed along with the automated scripts generated by the program from the recurring activities in previous sessions in the environment. An example of a type of script that the user might have is when an account manager pulls a report every time they reopen a workflow. The system will access the script by running the powershell command automating the user function of opening the report generating tool, selecting the required fields and downloading the file to the computer.

The event listener tracks user input to generate a current state for the environment that would allow the environment to be reconstructed on any computer at a later time. This logging continues until a user selects to save or close (430) the Sessions where a flag is raised to log all relevant actions (in the form of a state table) to a cloud storage solution for remote processing of recurring tasks (440). An example of a remote processing solution would be an instance or bucket in Amazon Web Services where the programs machine learning algorithm would reside to look for common sequences of actions by the user among different user sessions in the same workflow, for example opening certain applications with certain files to generate a given report. These tasks may be automated or semi automated for the user.

If the user choses to only save (450) the current session the event listener will still function in the specific environment. In the event the user moves to another environment, the event listener will transition to operating in that specific group instead of the previous (460). If the new environment is not open, time the state table for the new environment will be loaded to reconstruct that state. If the new environment is open and running, the program may simply make use of standard operating system functions to change a virtual desktop to the new environment. This process, however, is facilitated by a side menu that allows simple selection of the desktops by user assigned names. Lastly if the user selects to close the desired workflow the event listener will cease functions and wait to be called for a new or alternate workflow environment (470).

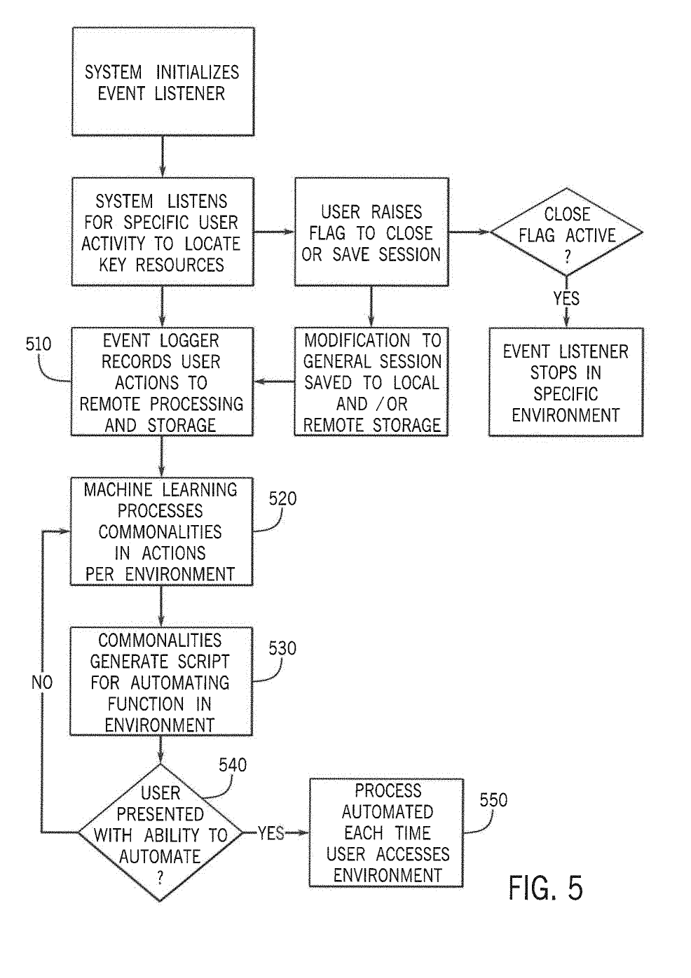

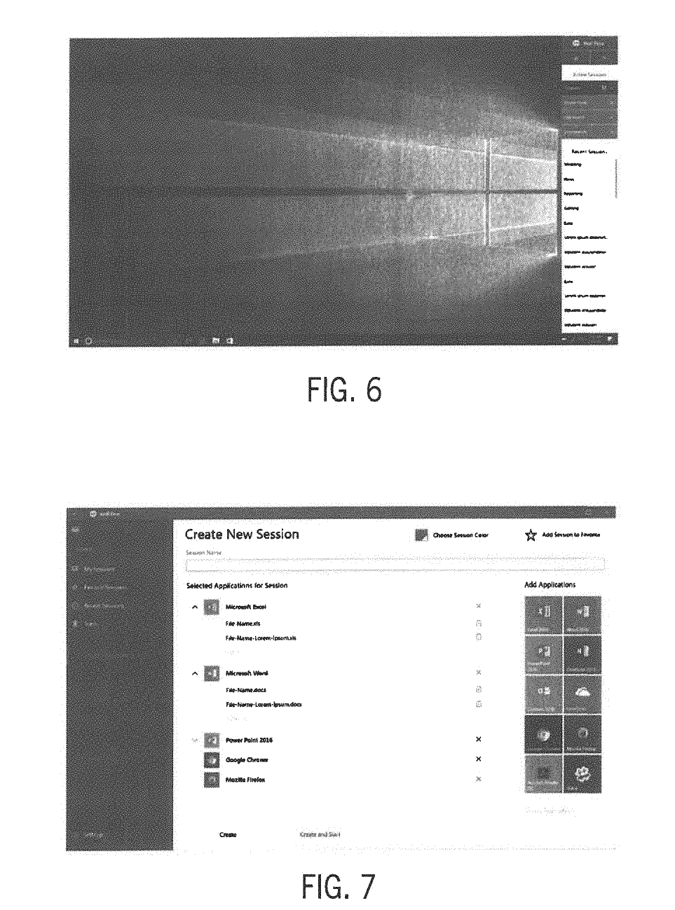

The Event Listener described in both FIG. 4 and FIG. 5 reports this data to the cloud to log all user actions from accessing necessary resources to system flow and records them to a remote storage solution described in FIG. 3 (510). The system then pushes the data through a machine learning algorithm to analyze and recognize common, recurring actions the user takes to complete a specific environment tasks (520). This is then leveraged to generate a script in the native Operating Systems language to automate these functions for the user (530). Once the script has been generated the user is given the option to use the automation script for future events (540). If the user clicks yes this script is run and will help reduce the time needed for task completion (550).

The Event Listener, when activated in a specific session, begins to count the amount of time a user is in the labeled environment. When a user switches outside of the labeled environment the clock is either paused (User only switches between Sessions) or stopped and recorded to the software (user closes Session).

The Event listener will also carry the capability of placing sessions outside of the active environment into “hibernation” mode which is pause all possible. In hibernation mode, the application programs and files remain as images in memory. Sessions outside of the active environment may also be shut down to release system resources of memory and processor time and then re-created using the state table when that environment receives focus again. In this way multiple environments can be created without adverse impact on system resources while still maintaining the accessibility of the workflows.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A computer user interface for workflow organization comprising:
electronic computer;
electronic memory holding a non-transient program together with executable applications and data files;
electronic display communicating with the electronic computer;
at least one human interface device controllable by a user to provide input to the electronic computer;
where in the electronic computer executing the non-transient program operates to:
(a) define a plurality of user defined tasks where necessary resources, applications and files are saved into respective sessions labeled by the user.
(b) track user activity for necessary resources, applications or files necessary for completion of a task using an event listening system monitoring the user's interaction with the tasks.
(c) recording low-level information of the user interaction to adds or remove resources, applications, and files to or from the respective session.
(d) receive input from the user to switch from an old session to a new session, and in response to this switching making available the necessary resources, applications and files related to a new session.

2. The computer user interface of claim 1 wherein the low-level information is aggregated on local and remote storage solutions.

3. The computer user interface of claim 1 further including the step of reviewing previous usage on the new session to find common actions to build an automation script for launching the new session.

4. The computer user interface of claim 3 further including the step of presenting the automation script to the user for automating functions of the session.

5. The computer user interface of claim 1 wherein the sessions with identification of associated resources, applications, and files are shared among multiple computers linked to a common login.
